(19) United States
(12) Patent Application Publication
(10) Pub. No.: US 2002/0064980 A1
(43) Pub. Date: May 30, 2002

(54) End feed connector for track lighting system

(76) Inventor: Liming Zhu, Hong Kong (CN)

Correspondence Address: ZITO TLP, 26005 RIDGE ROAD, SUITE 203, DAMASCUS, MD, 20872, US

(21) Appl. No.: 10/000,875

(22) Filed: Nov. 2, 2001

(30) Foreign Application Priority Data
Feb. 21, 2000 (CN) 00102779.4

(51) Int. Cl. H01R 25/00

(52) U.S. Cl. 439/115

(57) ABSTRACT

A kind of end feed connector for track lighting system, includes: a power cord connected with electric source and a “female” plug; said “female” plug contains electric conductor with several conductive flakes which connected with one end of the power cord, and a sealed insulation case containing an always-closed switch door in which said electric conductor is put. When powering on, there are not any bare charged bodies on this end feed connector in the present invention. It conforms to the international safety standards, and makes the installation of track lighting system more safe and convenient.

### FIELD OF THE INVENTION

The present invention relates to an end feed connector for track lighting system. Particularly to a portable end feed connector of the lighting track.

### BACKGROUND OF THE INVENTION

Track lighting system is used in factory, gallery, film studio at the beginning, then gradually spreading into family use, it becomes so popular that all sorts of track lighting system were sold in stores and supermarkets. After buying the track lighting system, the 1st problem user must face is the installation of lighting track (as track below), generally, track is installed on the ceiling or on the wall. There are two kinds of end feed connector of track lighting system nowadays. One is to connect directly the busbars of the lighting track with the wires fixed in junction box of the building, as FIG. 1 shows. This method is called the wiring of fixtures: the end feed connector 101 is put into the track, power cord 103 from the feed connector 101 is connected to wire 103 in junction box 102 of the building. But the shortage of this wiring method is that track must be installed near the junction box, as a result, normal user can't do it by oneself, and electrician is necessary when one want to install the track. Perhaps the installation cost is even greater than that of the whole set of track lighting system. And after fixing the lighting track, moreover the junction box is occupied forever. The position of the lighting track is at the mercy of the fixing position of the junction box. If there is no place for junction box, the track lighting system cannot be installed, furthermore it is rather inconvenient to install and change. And what is more, as a result of needing lots of fixture heads on the track sometimes, a junction box cannot afford its power consumption, so maybe one track system needs connect two junction boxes. The above shortages limit the sales and usage of the track lighting system. Another way is using a portable end feed connector, as FIG. 2 shows, a plug fitted for the track 202 is set. This plug connects with an attachment plug 201 with power cord. Owing to using ordinary attachment plug, it can plug in any electrical outlet, so that simplified the installation of track, expands fixing range of the track, supports existing overburden track, makes the installation and using of track lighting system easier. However its shortcoming is that plug 201 and plug 202 are both “male” plugs, plugs bare in the air. No matter which end is plugged in (track or electrical outlet), the bare opposite end may be active, so it can cause casualties by a sudden electric shock. Therefore this kind of connector is used and even sold in market, it could never pass the censorship of security, because it offend against the principle that there couldn't have two “male” plugs at each side of a power cord. Great danger might be here, it's illegal for selling and using this kind of connector.

### SUMMARY OF THE INVENTION

In view of shortages of the prior art, the object of the present invention is to provide a kind of end feed connector used for the lighting track which has not any bare active bodies by installing a “female” plug with a sealed insulation case, which is adaptable to the track. The present invention powerfully enhances safe level of the installation of track lighting system. This portable end feed connector can pass the censorship of security; also, it can be sold legally.

In order to achieve the above object, the end feed connector for lighting track in the present invention includes:

a power cord connected with electric source; and

a “female” plug connected with said power cord; wherein said “female” plug contains:

Electric conductor with several conductive flakes which connected with one end of said power cord; and

A sealed insulation case in which said electric conductor is put, including an always-closed switch door is set on said case, by pushing the door open the end of lighting track can enter into the sealed insulation case.

Shape and size of said always-closed switch door are adaptable to the end of the track.

The end feed connector also consists of a strain relief device in the insulation case used for fixing the power cord.

Between the electric conductor and the always-closed switch door, there is enough space, so the end of the track of track lighting have safe space to move forward before touching said conductive flakes.

The always-closed switch door is a spring door.

The always-closed switch door is a turnover spring door.

The always-closed switch door is a direct-moved spring door.

At the end of the power cord, there is an attachment plug for socket power.

The sealed insulation case is made of thermoplastics.

The sealed insulation case is made of thermosetting material.

### BRIEF DESCRIPTION OF THE DRAWINGS

The following shows the description of preferred embodiments of the present invention with reference to the related drawings.

FIG. 1 is a stereoscopic breakdown drawing of the installation of traditional single-phase three-wire system lighting track;

FIG. 2 is a stereoscopic schematic drawing. of the present portable end feed connector;

FIG. 3 is a section structural drawing of a preferred embodiment of the present invention;

FIG. 4 is a stereoscopic breakdown drawing of a preferred embodiment of the present invention.

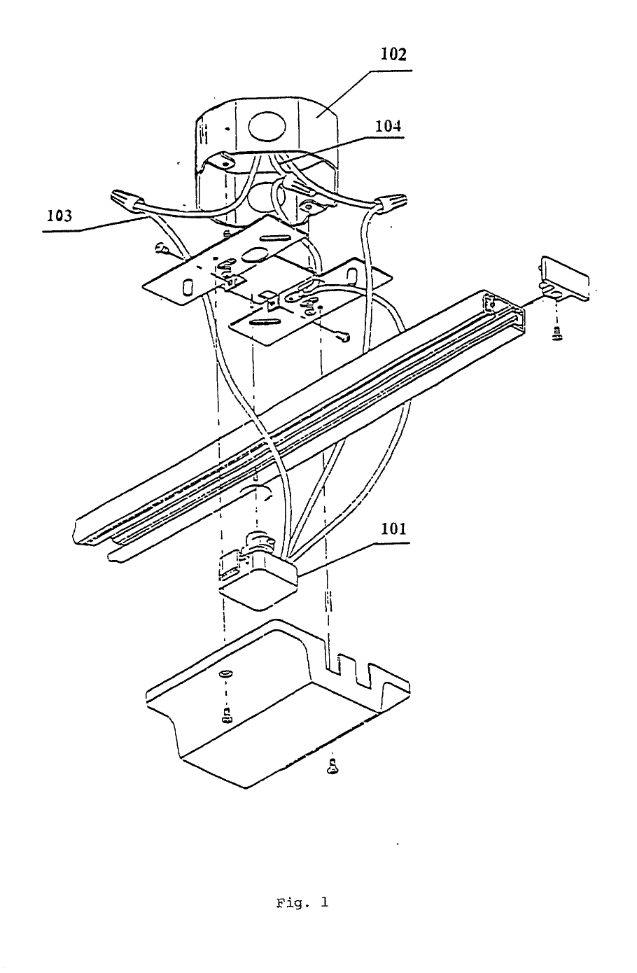

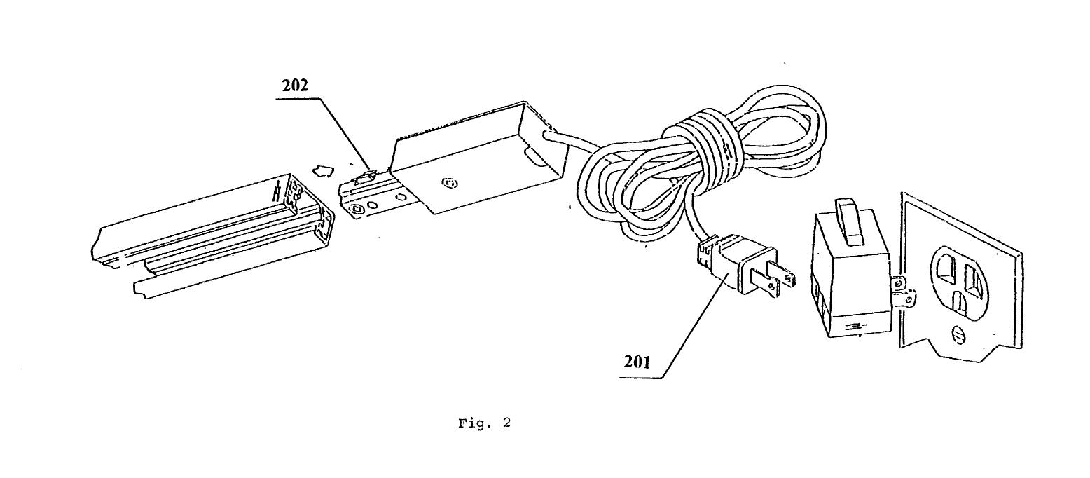

### DETAILED DESCRIPTION OF PREFERRED EMBODIMENTS

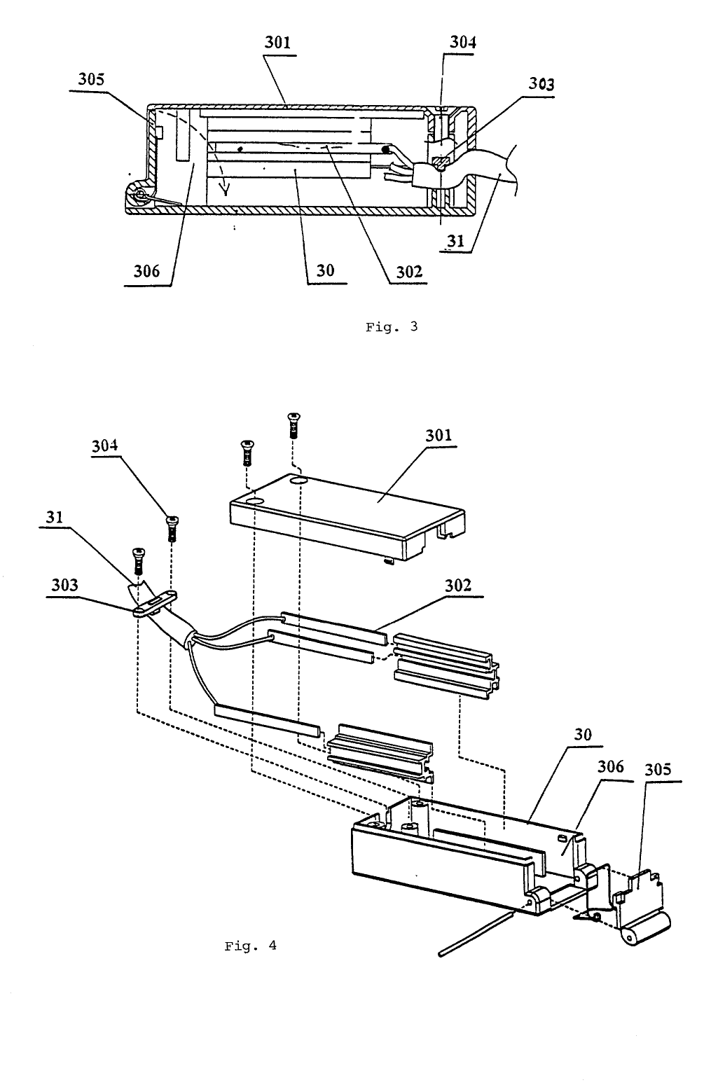

A preferred embodiment of the present invention is shown in FIGS. 3 and 4. The end feed connector for lighting track includes a power cord 31 connected with power source. The power cord can either directly connect with junction box of the building, or integrate an attachment plug (not drawn in the figure) at the end of it so that it can plug in power source; hence, it is called portable end feed connector. The end feed connector also includes a “female” plug 30. The “female” plug contains: electric conductor 302 with three conductive flakes that connected with one end of the power cord; a strain relief device of the power cord that consists of a cord grip 303 and two stopper screws 304; and an insulation case 301. The insulation case 301 can be molding as two parts, the upper one and the lower one, which lump together by screws (FIG. 4). Electric conductor 302 and strain relief device of the power cord is set in the insulation case 301, which is made by thermoplastics. So the case has good electricity insulation and necessary mechanical property. Other insulation material is also available, such as thermosetting bakelite, which seals all the charged units in that case. A spring door 305 is set on the insulation case, its shape and size are adaptable to the track end of the lighting track, between electric conductor 302 and spring door 305, there is certain space 306. Only when plugging in the spring door and moving a safe distance forward, the track end can be conducted with the electric conductor in the insulation case of the “female” plug. The force necessary for plugging in the spring door should equal to what Strain Relief Prescribe of the power cord of the device. Eleven-kilogram is adequate to reach the Strain Relief Prescribe of IEC Safety Standard (China adopt this standard), then, if a naughty boy can plug his finger in the spring door, he can pull the power cord away from the strain relief device with the same force.

All sorts of ways can be used in opening the spring door. For instance, the turnover type, which includes turn axis and springs beside or opposite the door, is a spring door that could be opened by side or opposite side turning when the track plugs in. The direct-moved type, which includes springs over and under the door, is one that could be opened by compressed the spring when the track plugs in.

When disassembling, the present device should be took apart from the end of the track first, because when the two parts is departed they both are the “female” plugs with insulation protection, so not to cause an electric shock. And then pull out the plug of the device from electrical outlet.

Although all the embodiments given here are based on single-phase three-wire system, those skilled in the art can easily change them into a device used for three-phase four-wire system. They belong to the scope of the present invention too.

Above embodiments shows the great advantage of the invention clearly:

1. It makes installation of the present fixed wiring track system break away from limitation of the junction box safely and legally. It simplifies installation of the track system. Without asking for electrician, all that we should do is: install the track on the ceiling or wall, then insert the attachment plug into electrical outlet. This may let more people buy track lighting system.

2. The use of the end feed connector of the present invention would not occupy a junction box, for omnipotence electrical outlet can be used at electrical outlet, that is to say, it can share one electrical outlet with other electrical equipment.

3. The device of the invention can cooperate with present track, users who have bought lighting track need buy an end feed connector of the present invention only, they can keep on using their old system more safely. The present invention guarantees user's safety without much outlay, that also means a wonderful market prospect of the present invention.

Although particular embodiments of the present invention have been described in the foregoing description, it should be understood by those skilled in the art that the invention is capable of numerous modifications, substitutions and rearrangements without departing from the spirit or essential attributes of the invention. Reference should be made specification, as indicating the scope of the invention.

1. A kind of end feed connector for track lighting system, including
power cord connected with electrical source; and
a “female” plug connected with said power cord; wherein said “female” plug contains:
Electric conductor with several conductive flakes which connected with one end of said power cord; and
A sealed insulation case in which said electric conductor is put, including an always-closed switch door on the case, by pushing the door open the end of lighting track can enter into said sealed insulation case:

2. An end feed connector according to claim 1, wherein the shape and size of the always-closed switch door are adaptable to the end of the said lighting track.

3. An end feed connector according to claim 2, wherein said end feed connector also consists of a strain relief device in the insulation case used for fixing said power cord.

4. An end feed connector according to claim 2 or 3, wherein between the electric conductor and the always-closed switch door, there is enough space, so the end of the lighting track have safe space to move forward before touching the conductive flakes.

5. An end feed connector according to claim 1, wherein said always-closed switch door is a spring door.

6. An end feed connector according to claim 5, wherein said always-closed switch door is a turnover spring door.

7. An end feed connector according to claim 5, wherein said always-closed switch door is a direct-moved spring door.

8. An end feed connector according to claim 1, wherein at the end of the power cord, there is an attachment plug for socket power.

9. An end feed connector according to claim 1, wherein said sealed insulation case is made of thermoplastics.

10. An end feed connector according to claim 1, wherein said sealed insulation case is made of thermosetting material.
